(19) United States
(12) Patent Application Publication
(10) Pub. No.: US 2009/0234824 A1
(43) Pub. Date: Sep. 17, 2009

(54) Browser Use of Directory Listing for Predictive Type-Ahead

(75) Inventor: Eric P. Fried, Austin, TX (US)

Correspondence Address: Cahn & Samuels, LLP, 1100 17th St., NW, Ste. 401, Washington, DC, 20036, US

(73) Assignee: INTERNATIONAL BUSINESS MACHINES CORPORATION, Armonk, NY (US)

(21) Appl. No.: 12/252,867

(22) Filed: Oct. 16, 2008

Related U.S. Application Data
(63) Continuation of application No. 12/048,808, filed on Mar. 14, 2008.

(51) Int. Cl. G06F 7/06; G06F 17/30

(52) U.S. Cl. 707/4

(57) ABSTRACT

A system and method for providing a predictive browser type-ahead that performs server queries of computer file directory listings in order to locate and present matching Universal Resources Locator (URL) extensions as the URL is entered into the browser. The predictive type-ahead provides matching URL entries into the browser for user selection. The predictive type-ahead also continually validates the browser entries as they are made.

### I. CROSS-REFERENCE TO RELATED APPLICATIONS

This application is a continuation application of U.S. patent application Ser. No. 12/048,808 filed Mar. 14, 2008, the entirety of which is incorporated herein by reference.

### II. FIELD OF THE INVENTION

This invention relates to a system and method that provides a predictive browser type-ahead by performing server queries of the computer file directory listings in order to locate and present matching Universal Resources Locator (URL) extensions as the URL is entered into the browser.

### III. BACKGROUND OF THE INVENTION

The World Wide Web (web or internet) consists of a web of remote, linked computer networks. This web of computer networks, referred to as the internet, facilitates the remote exchange of information and communication between its users. Computer networks designed to operate in the internet environment are generally designed to operate on a client/server platform. The information made available on the internet is stored on the various remote computers or servers. These servers allow other computers or clients to access the information stored on the servers via the internet. The client typically utilizes a software program or “browser” stored on the client computer to request information from the server.

Internet users often utilize the browser to search or “browse” various websites for information. The information on these websites is generally organized by pages (“web page”) each having its own address or identification code called a Uniform Resource Locator (“URL”). URLs are often long strings of characters and due to the sheer number of websites and web pages available, it can be very difficult to remember and enter the appropriate URL each time a page is desired.

In order to become more user friendly, many browsers maintain a stored list of URLs associated with recently visited web pages. As a user begins to type a partial URL into the browser the user is presented with various complete URLs matching the partial URL. However, this function is only available when there are recently visited and stored URLs that match the partial URL. This function does not work with URLs that are not stored, for example, in the browser history. These stored URLs are typically limited to those that were recently visited. Therefore, URLs that have not been visited recently or ever visited, depending on the particular system and settings, are not stored. Also, if the URL is misspelled this function is rendered useless.

Browsers are also similarly used to search and retrieve files located on a local or network directory listing. These files are typically organized by folders and file extensions and require that the entire extension be entered to locate the file.

Notwithstanding the usefulness of the above-described methods, a need still exists for a browser that provides predictive type-ahead completions of URL entries for URLs other than those recently visited.

### IV. SUMMARY OF THE INVENTION

In at least one exemplary embodiment, the present invention provides a method for presenting a predictive type-ahead of a Uniform Resources Locator (URL) in a computer browser, including: receiving at least a partial URL entry into a browser; searching a computer directory listing based on each keystroke of said partial URL entry; presenting only the full directory listings that match the partial URL as currently entered; and determining whether each of said keystrokes is a directory separator, and if said keystroke is a directory separator, perform a directory listing query to complete said URL; determining whether each of said keystrokes is a question mark, and if said keystroke is a question mark, end attempts to present full directory listings that match the partial URL; determining whether each of said keystrokes is a backspace, and if said keystroke is a backspace, delete the currently presented URLs; generating a substring list of said URL beginning with the last directory separator in the URL; discard any URLs that do not match the substring list; presenting the matching substring list in said browser; and updating a status indicator of said matching substring.

An advantage of the present invention is that it utilizes computer directory listings to provide predictive type-aheads and entry validation for browser entries.

Given the following enabling description of the drawings, the apparatus should become evident to a person of ordinary skill in the art.

### V. BRIEF DESCRIPTION OF THE DRAWINGS

The present invention is described with reference to the accompanying drawings, wherein:

FIG. 1 illustrates hardware components in accordance with an exemplary embodiment of the present invention.

FIG. 2 illustrates a predictive browser type-ahead and validation method in accordance with an exemplary embodiment of the present invention.

Given the following enabling description of the drawings, the apparatus should become evident to a person of ordinary skill in the art.

### VI. DETAILED DESCRIPTION OF THE DRAWINGS

The present invention provides a system and method for performing computer server queries of directory listings in response to a browser entry in order to present predictive type-ahead, single-directory completions of the browser entry as the entry is performed. The present invention serves to continually validate the URL as it is entered and to present complete predictive type-aheads of all directory listings that match the URL as entered. The system allows a user to identify and set one or more directories to query in order to complete the predictive type-aheads. The system and method thereby improves efficiency and ease of use by quickly validating and presenting a list of matches for the entered URL as typed.

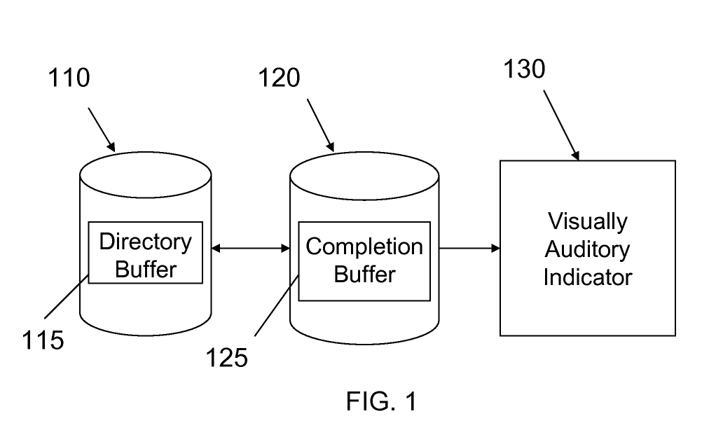

In at least one exemplary embodiment, as illustrated in FIG. 1, the system of the present invention utilizes at least one directory 110 including a directory buffer 115, at least one completion buffer 120 including a completion buffer 125, and at least one indicator 130. The directory buffer 115 contains a comprehensive list of the contents of the directory 110 that is being queried. The completion buffer 125 contains a filtered version of the comprehensive list from directory buffer 115. The filtered version of the completion buffer 125 represents only those URL completions that match the complete URL as typed. The visual indicator 130 indicates the state of the URL and may be visual and/or audible. The visual indicator 130 provides an indication of the following URL states: “OK”, “Does Not Exist”, “No Directory Listing Permission”, and “No Permission At All”.

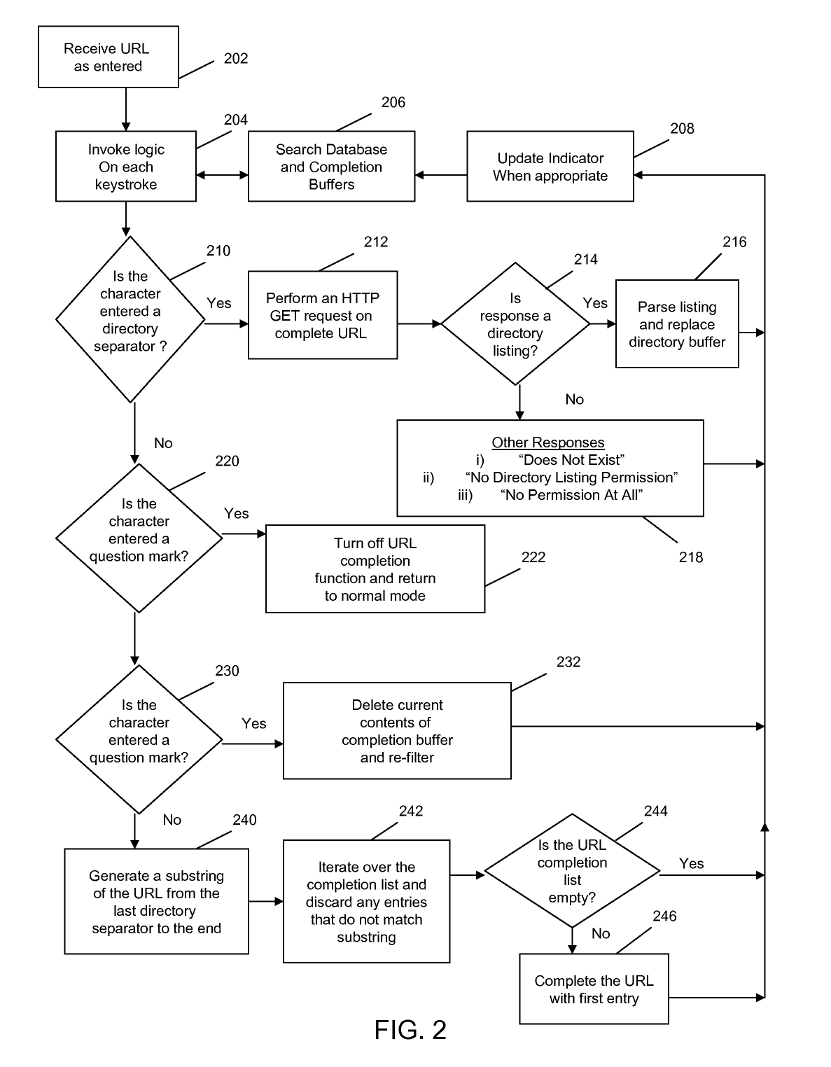

An exemplary method of the present invention is illustrated in FIG. 2. The method begins at 202 when a URL is entered into the browser. At 204, the logic of the present invention is invoked on each keystroke of the URL entry. At 206, the database buffer and completion buffers are searched for matching entries for the URL. The method cycles between 204 and 206 upon each keystroke entry and proceeds to 210. At 210, the method determines whether the entered character is a directory separator. If “Yes”, the method proceeds to 212 and performs an HTTP GET request on the complete URL. The method then proceeds to 214 and determines whether the response to the request at 212 is a directory listing. If “Yes”, the method proceeds to 216, parses the listing and replaces the directory buffer. The method then proceeds to 208 and updates the indicator to the “OK” state. If “No” is the determination at 214, the method proceeds to 218, indicates the appropriate “other” URL response, i.e., “Does Not Exist”, “No Directory Listing Permission”, or “No Permission At All”. The method then proceeds to 208 and updates the indicator, as appropriate (update of the indicator may not always be required or appropriate).

If “No” is the determination at 210, the method proceeds to 220 and determines whether the entered character entered is a question mark, i.e., the beginning of a query string. If “Yes”, the method proceeds to 222, turns off the URL completion feature and returns to normal mode. If “No”, the method proceeds to 230 and determines whether the entered character is a backspace. If “Yes”, the method proceeds to 232, deletes the current contents of the URL completion buffer and re-filters the completion buffer based on the remaining characters. The method then cycles back to 208 and updates the indicator, as appropriate. If “No”, the method proceeds to 240 and generates a substring of the URL from the last directory separator to the end. At 240, the method iterates over the completion list and discards any entries that do not match the substring. At 244, the method determines whether the URL completion list is empty. If “Yes”, the method then cycles back to 208 and updates the indicator, as appropriate. If “No”, the method proceeds to 246 and completes the URL with the first URL entry. The method then cycles back to 208 and updates the indicator, as appropriate.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

The exemplary embodiments described above may be combined in a variety of ways with each other. Furthermore, the steps and number of the various steps illustrated in the figures may be adjusted from that shown.

Although the present invention has been described in terms of particular exemplary embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary embodiments described above can be configured without departing from the scope and spirit of the invention. Therefore, it is to be understood that, within the scope of the appended claims, the invention may be practiced other than as specifically described herein.

We claim:

1. A method for presenting a predictive type-ahead of a Uniform Resources Locator (URL) in a computer browser, comprising:
receiving at least a partial URL entry into a browser;
searching a computer directory listing based on each keystroke of said partial URL entry;
presenting only the full directory listings that match the partial URL as currently entered; and
determining whether each of said keystrokes is a directory separator,
and if said keystroke is a directory separator, perform a directory listing query to complete said URL;
determining whether each of said keystrokes is a question mark,
and if said keystroke is a question mark, end attempts to present full directory listings that match the partial URL;
determining whether each of said keystrokes is a backspace,
and if said keystroke is a backspace, delete the currently presented URLs;
generating a substring list of said URL beginning with the last directory separator in the URL;
discard any URLs that do not match the substring list;
presenting the matching substring list in said browser; and
updating a status indicator of said matching substring.
